(19) United States
(12) Patent Application Publication
(10) Pub. No.: US 2026/0180706 A1
(43) Pub. Date: Jun. 25, 2026

(54) SIGNAL TRANSMISSION SYSTEM, OPTICAL TRANSMISSION APPARATUS AND SIGNAL TRANSMISSION METHOD

(71) Applicant: NTT, Inc, Tokyo (JP)

(72) Inventors: Kenji MIYAMOTO, Musashino-shi (JP); Yoshihito SAKAI, Musashino-shi (JP); Tatsuya SHIMADA, Musashino-shi (JP)

(73) Assignee: NTT, Inc., Tokyo (JP)

(21) Appl. No.: 19/125,870

(22) PCT Filed: Nov. 4, 2022
(86) PCT No.: PCT/JP2022/041116

§ 371 Date: Apr. 30, 2025

(51) Int. Cl. H04J 14/02

(52) U.S. Cl. CPC H04J 14/0246

(57) ABSTRACT

In a signal transmission system including: one or more first communication devices that accommodate one or more wireless terminals that transmit a plurality of traffic flows; and an optical transmission device that transmits a signal transmitted between the first communication devices and a second communication device, each of the first communication devices includes a communication control unit that performs scheduling of time and frequency for each of the traffic flows and transmits scheduling result information indicating a result of the scheduling and traffic flow information indicating a state of the traffic flows in a wireless section to the optical transmission device, and the optical transmission device includes an optical transmission control unit that allocates a wavelength in a wired section to each of the traffic flows for each time section on a basis of the scheduling result information and the traffic flow information transmitted from the communication control unit.

### TECHNICAL FIELD

The present invention relates to a signal transmission system, an optical transmission apparatus and a signal transmission method.

### BACKGROUND ART

Conventionally, there is a mobile communication system including a wireless section between a plurality of wireless terminals and a base station and a wired section between the base station and a server, in which the plurality of wireless terminals and the server mutually transmit a plurality of traffic flows to each other via the base station. In such a mobile communication system, in a wireless section, a plurality of traffic flows is multiplexed on a wireless frequency axis according to scheduling by a base station and transmitted in parallel. On the other hand, in a wired section, one wavelength of light is allocated, a plurality of traffic flows is time-divisionally multiplexed on the time axis, and a signal is transmitted via an optical transmission device included between the base station and a server.

### CITATION LIST

### Non Patent Literature

Non Patent Literature 1: “3GPP TS 23.501 V17.5.0”, 3GPP, 2022.
Non Patent Literature 2: “3GPP TS 38.300 V17.1.0”, 3GPP, 2022.
Non Patent Literature 3: Y Abiko, et al., “Flexible Resource Block Allocation to Multiple Slices for Radio Access Network Slicing Using Deep Reinforcement Learning,” IEEE Access, vol. 8, pp. 68183-68198, 2020.

### SUMMARY OF INVENTION

### Technical Problem

In the mobile communication system as described above, since signal serialization is required in time-division multiplexing in a wired section, a delay may occur. As a result, conventionally, there is an issue that a traffic flow that cannot satisfy a predetermined delay requirement may occur.

The present invention has been made in view of the above technical background, and an object thereof is to provide a signal transmission system, an optical transmission apparatus and a signal transmission method capable of reducing a delay caused by signal serialization.

### Solution to Problem

One aspect of the present invention is a signal transmission system including: one or more first communication devices that accommodate one or more wireless terminals that transmit a plurality of traffic flows; and an optical transmission device that transmits a signal transmitted between the first communication devices and a second communication device, in which each of the first communication devices includes a communication control unit that performs scheduling of time and frequency for each of the traffic flows and transmits scheduling result information indicating a result of the scheduling and traffic flow information indicating a state of the traffic flows in a wireless section to the optical transmission device, and the optical transmission device includes an optical transmission control unit that allocates a wavelength in a wired section to each of the traffic flows for each time section on a basis of the scheduling result information and the traffic flow information transmitted from the communication control unit.

Furthermore, one aspect of the present invention is a signal transmission system including: one or more first communication devices that accommodate one or more wireless terminals that transmit a plurality of traffic flows; an optical transmission device that transmits a signal transmitted between the first communication devices and a second communication device; and a controller that controls the optical transmission device, in which each of the first communication devices includes a communication control unit that performs scheduling of time and frequency for each of the traffic flows and transmits scheduling result information indicating a result of the scheduling and traffic flow information indicating a state of the traffic flows in a wireless section to the optical transmission device, the controller includes an optical transmission control unit that allocates a wavelength in a wired section to each of the traffic flows for each time section on a basis of the scheduling result information and the traffic flow information transmitted from the communication control unit, and the second communication device includes a control execution unit that controls communication in the wired section according to allocation of the wavelength by the optical transmission control unit.

Furthermore, one aspect of the present invention is an optical transmission device that transmits a signal transmitted between one or more first communication devices that accommodate one or more wireless terminals that transmit a plurality of traffic flows and a second communication device, the optical transmission device including an optical transmission control unit that allocates a wavelength in a wired section to each of the traffic flows for each time section on a basis of scheduling result information indicating a result of scheduling of time and frequency for each of the traffic flows and traffic flow information indicating a state of the traffic flows in a wireless section.

Furthermore, one aspect of the present invention is a signal transmission method by a signal transmission system including: one or more first communication devices that accommodate one or more wireless terminals that transmit a plurality of traffic flows; and an optical transmission device that transmits a signal transmitted between the first communication devices and a second communication device, the signal transmission method including: a communication control step of, by each of the first communication devices, performing scheduling of time and frequency for each of the traffic flows and transmitting scheduling result information indicating a result of the scheduling and traffic flow information indicating a state of the traffic flows in a wireless section to the optical transmission device; and an optical transmission control step of, by the optical transmission device, allocating a wavelength in a wired section to each of the traffic flows for each time section on a basis of the scheduling result information and the traffic flow information transmitted by the communication control step.

Furthermore, one aspect of the present invention is a signal transmission method by a signal transmission system including: one or more first communication devices that accommodate one or more wireless terminals that transmit a plurality of traffic flows; an optical transmission device that transmits a signal transmitted between the first communication devices and a second communication device; and a controller that controls the optical transmission device, the signal transmission method including: a communication control step of, by each of the first communication devices, performing scheduling of time and frequency for each of the traffic flows and transmitting scheduling result information indicating a result of the scheduling and traffic flow information indicating a state of the traffic flows in a wireless section to the optical transmission device; an optical transmission control step of, by the controller, allocating a wavelength in a wired section to each of the traffic flows for each time section on a basis of the scheduling result information and the traffic flow information transmitted by the communication control step; and a control execution step of, by the second communication device, controlling communication in the wired section according to allocation of the wavelength in the optical transmission control step.

Furthermore, one aspect of the present invention is a signal transmission method by an optical transmission device that transmits a signal transmitted between one or more first communication devices that accommodate one or more wireless terminals that transmit a plurality of traffic flows and a second communication device, the signal transmission method including: an acquisition step of acquiring scheduling result information indicating a result of scheduling of time and frequency for each of the traffic flows and traffic flow information indicating a state of the traffic flows in a wireless section; and an optical transmission control step of allocating a wavelength in a wired section to each of the traffic flows for each time section on a basis of the scheduling result information and the traffic flow information acquired by the acquisition step.

### Advantageous Effects of Invention

According to the present invention, it is possible to reduce a delay caused by signal serialization.

### BRIEF DESCRIPTION OF DRAWINGS

FIG. 1 is a block diagram illustrating an overall configuration of a conventional signal transmission system 6.

FIG. 2 is a block diagram illustrating an overall configuration of a signal transmission system 1 according to a first embodiment of the present invention.

FIG. 3 is a flowchart illustrating operation of the signal transmission system 1 according to the first embodiment of the present invention.

FIG. 4 is a block diagram illustrating an overall configuration of a signal transmission system 1a according to a second embodiment of the present invention.

FIG. 5 is a block diagram illustrating an overall configuration of a signal transmission system 1b according to a third embodiment of the present invention.

FIG. 6 is a schematic diagram illustrating an example of a configuration of downlink signal transmission by a signal transmission system in a conventional technology.

FIG. 7 is a schematic diagram illustrating an example of a configuration of downlink signal transmission by the signal transmission system 1b according to the third embodiment of the present invention.

FIG. 8 is a block diagram illustrating an overall configuration of a signal transmission system 1c according to a fourth embodiment of the present invention.

FIG. 9 is a block diagram illustrating an overall configuration of a signal transmission system 1d according to a fifth embodiment of the present invention.

FIG. 10 is a block diagram illustrating an overall configuration of a signal transmission system 1e according to a sixth embodiment of the present invention.

### DESCRIPTION OF EMBODIMENTS

### First Embodiment

Hereinafter, a signal transmission system, an optical transmission device, and a signal transmission method according to a first embodiment of the present invention will be described with reference to the drawings.

Hereinafter, in order to make description of a configuration of a signal transmission system according to an embodiment easy to understand, an example of a configuration of a conventional signal transmission system will be described first as a comparison target.

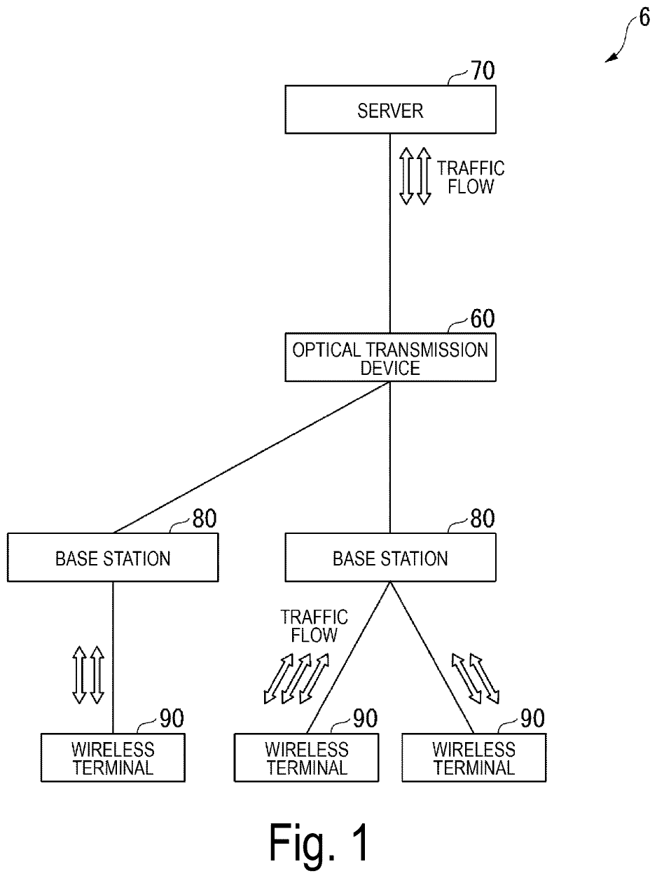

FIG. 1 is a block diagram illustrating an overall configuration of a conventional signal transmission system 6. As illustrated in FIG. 1, the signal transmission system 6 includes an optical transmission device 60, a server 70, a plurality of base stations 80, and a plurality of wireless terminals 90. Note that in FIG. 1, as an example, two base stations 80 and three wireless terminals 90 are illustrated, but the number of base stations 80 and the number of wireless terminals 90 may be any number.

The optical transmission device 60 is included in signal transmission paths between the server 70 and the base stations 80. The optical transmission device 60 is a transfer device that transmits signals mutually transmitted between the server 70 and the wireless terminals 90.

The server 70 is a communication device that mutually performs transmission of a plurality of traffic flows with a plurality of wireless terminals 90 via the optical transmission device 60 and the base stations 80. Each of the wireless terminals 90 is a communication device that mutually performs transmission of a plurality of traffic flows with the server 70 via the base station 80 and the optical transmission device 60.

Each of the base stations 80 accommodates a plurality of wireless terminals 90. Each of the base stations 80 is a communication device that mutually performs wireless signal transmission with the wireless terminals 90 and mutually performs wired signal (optical signal) transmission with the optical transmission device 60. Each of the base stations 80 transmits signals received from the wireless terminals 90 to the optical transmission device 60, and transmits a signal received from the optical transmission device 60 to the wireless terminals 90.

As described above, the signal transmission system 6 is a mobile communication system in which the wireless terminals 90 and the server 70 mutually transmit a plurality of traffic flows to each other via the base stations 80 and the optical transmission device 60. In the signal transmission system 6, a section between the wireless terminals 90 and the base stations 80 is a wireless section in which wireless signal transmission is performed. On the other hand, a section between the base stations 80 and the server 70 is a wired section in which wired signal transmission is performed.

For example, in a mobile communication system in which a server and a plurality of wireless terminals mutually transmit a plurality of traffic flows to each other as in the signal transmission system 6, generally, an identifier of a network class such as network slice selection assistance information (NSSAI) or an identifier of quality of service (QoS) class (class of quality of service) such as 5G QoS identifier (5QI) (see, for example, Non Patent Literature 1) may be given to each traffic flow.

In the signal transmission system 6, a plurality of traffic flows is multiplexed on a wireless frequency axis and transmitted in parallel in the wireless section. On the other hand, in the wired section, one wavelength of light is allocated, a plurality of traffic flows is time-divisionally multiplexed on the time axis, and a signal is transmitted via the optical transmission device 60. In the signal transmission system 6, each of the base stations 80 performs scheduling of time and frequency in the wireless section, and the above-described signal transmission is performed according to a result of the scheduling.

In a conventional mobile communication system such as the signal transmission system 6 as described above, since signal serialization is required in time-division multiplexing in a wired section, a delay occurs. As a result, a traffic flow that cannot satisfy a predetermined delay requirement may occur. Hereinafter, a signal transmission system, an optical transmission device, and a signal transmission method according to the first embodiment of the present invention that solve such issues will be described.

In the signal transmission system 1 according to the first embodiment described below, similarly to the conventional signal transmission system 6, each of base stations 30 described below performs scheduling of time and frequency in a wireless section. Then, each of the base stations 30 transmits a control signal indicating the scheduling result (for example, result of resource allocation of time and frequency or the like) and the state of traffic flows in the wireless section (for example, number of wireless terminals, identifiers for respective traffics, or the like) to an optical transmission device 10 described below.

Then, the optical transmission device 10 allocates a plurality of wavelengths to the respective traffic flows for a wired section according to the acquired state of the traffic flows and scheduling result. As described above, in the conventional signal transmission system 6 described above, a signal is transmitted by time division multiplexing using one wavelength in the wired section, whereas in the signal transmission system 1 according to the first embodiment described below, a signal is transmitted by wavelength division multiplexing using a plurality of wavelengths in the wired section.

With such a configuration, the signal transmission system 1 according to the first embodiment described below can transmit a plurality of traffic flows in parallel by wavelength division multiplexing even in the wired section between a server 20 and the base stations 30 described below. As a result, the signal transmission system 1 according to the first embodiment can reduce occurrence of a delay caused by signal serialization by time division multiplexing, which occurs in the wired section of the conventional signal transmission system 6.

Furthermore, in a conventional mobile communication system such as the signal transmission system 6 described above, in a case where a plurality of wavelengths is allocated in one base station, a wavelength corresponding to a traffic flow to which a frequency resource is not allocated in a wireless section of a certain time section is wasted. As a result, excessive wavelength allocation occurs, and the utilization efficiency of wavelengths decreases.

On the other hand, in the signal transmission system 1 according to the first embodiment described below, the optical transmission device 10 allocates only a wavelength corresponding to a traffic flow to which a frequency resource is allocated in the wireless section for each time section. As a result, the number of wavelengths used is reduced, and the utilization efficiency of wavelengths is improved.

### [Configuration of Signal Transmission System]

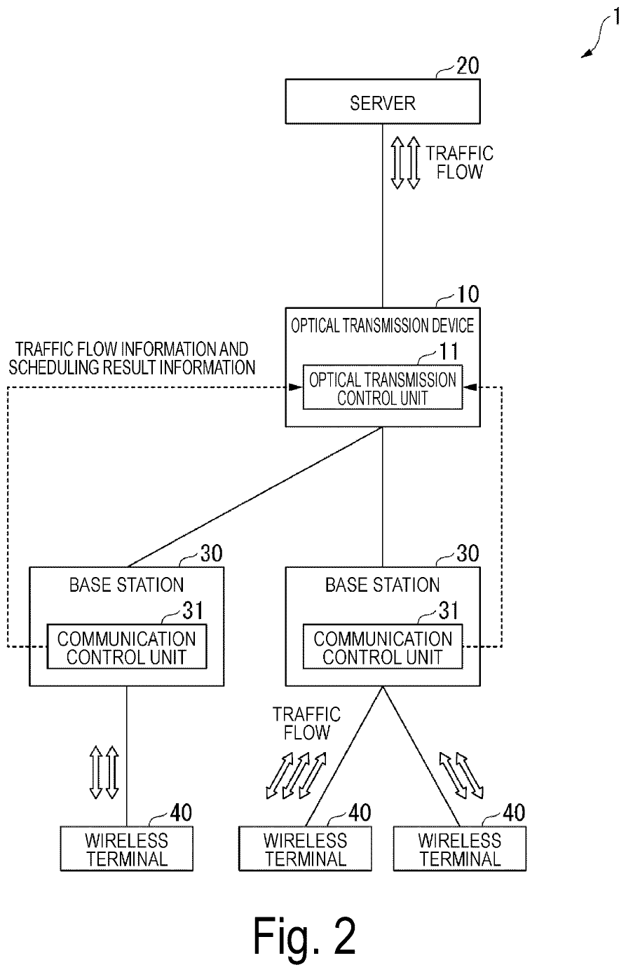

FIG. 2 is a block diagram illustrating an overall configuration of the signal transmission system 1 according to the first embodiment of the present invention. As illustrated in FIG. 2, the signal transmission system 1 includes the optical transmission device 10, the server 20, a plurality of the base stations 30, and a plurality of wireless terminals 40. Note that in FIG. 2, as an example, two base stations 30 and three wireless terminals 40 are illustrated, but the number of base stations 30 and the number of wireless terminals 40 may be any number.

The optical transmission device 10 is included in signal transmission paths between the server 20 and the base stations 30. The optical transmission device 10 is a transfer device that transmits signals mutually transmitted between the server 20 and the wireless terminals 40.

The server 20 is a communication device that mutually performs transmission of a plurality of traffic flows with a plurality of wireless terminals 40 via the optical transmission device 10 and the base stations 30. Each of the wireless terminals 40 is a communication device that mutually performs transmission of a plurality of traffic flows with the server 20 via the base station 30 and the optical transmission device 10.

Each of the base stations 30 accommodates a plurality of wireless terminals 40. Each of the base stations 30 is a communication device that mutually performs wireless signal transmission with the wireless terminals 40 and mutually performs wired signal (optical signal) transmission with the optical transmission device 10. Each of the base stations 30 transmits signals received from the wireless terminals 40 to the optical transmission device 10, and transmits a signal received from the optical transmission device 10 to the wireless terminals 40.

As described above, the signal transmission system 1 is a mobile communication system in which the wireless terminals 40 and the server 20 mutually transmit a plurality of traffic flows to each other via the base stations 30 and the optical transmission device 10. In the signal transmission system 1, a section between the wireless terminals 40 and the base stations 30 is a wireless section in which wireless signal transmission is performed. On the other hand, a section between the base stations 30 and the server 20 is a wired section in which wired signal transmission is performed.

In the signal transmission system 1, an identifier of a network class such as NSSAI or an identifier of a QoS class such as 5QI is given to each traffic flow.

As illustrated in FIG. 2, the optical transmission device 10 includes an optical transmission control unit 11. Furthermore, each of the base stations 30 includes a communication control unit 31. The communication control unit 31 of each of the base stations 30 transmits traffic flow information and scheduling result information to the optical transmission control unit 11 of the optical transmission device 10.

The traffic flow information here is information regarding a traffic flow established at the time of connection between the base station 30 and the wireless terminal 40. Specifically, the traffic flow information is, for example, an identifier (ID) for identifying the wireless terminal 40, an ID for identifying a traffic flow, an identifier for identifying a QoS class, an identifier for identifying a network slice, or the like.

Furthermore, the scheduling result information here is information indicating a result obtained by the base station 30 performing scheduling of time and frequency for each traffic flow in the wireless section for each time section on the basis of wireless feedback information successively transmitted from the wireless terminals 40. Specifically, the wireless feedback information is, for example, information indicating the remaining amount of a buffer for each traffic flow in the wireless terminal 40, information indicating the quality of a wireless channel, or the like.

The optical transmission control unit 11 of the optical transmission device 10 acquires the traffic flow information and the scheduling result information transmitted from the communication control unit 31 of each of the base stations 30. On the basis of the acquired traffic flow information and scheduling result information, the optical transmission control unit 11 divides a time section and allocates a wavelength used in the wired section (that is, wavelength used between the server 20 and the optical transmission device 10 and wavelength used between the optical transmission device 10 and each of the base stations 30) to each traffic flow for each of the base stations 30.

Note that the above-described wavelength allocation may be performed for each of the wireless terminals 40. Alternatively, the above-described wavelength allocation may be performed for each identifier of a QoS class of a traffic flow or for each identifier of a network slice.

Note that the above-described wavelength allocation may be performed for each subcarrier of an optical orthogonal frequency division multiplexing (OFDM) signal.

Note that each of the base stations 30 may include, for example, a wavelength tunable transceiver (not illustrated), and a wavelength allocated by the optical transmission control unit 11 may be used both between the base stations 30 and the optical transmission device 10 and between the optical transmission device 10 and the server 20. Alternatively, the wavelength allocated by the optical transmission control unit 11 may be used only between the optical transmission device 10 and the server 20, and a signal may be transmitted by time division multiplexing using one wavelength between the base stations 30 and the optical transmission device 10, similarly to the signal transmission system 6 illustrated in FIG. 1 described above.

Note that, instead of the base stations 30, the optical transmission control unit 11 of the optical transmission device 10 may perform scheduling in the wireless section described above. That is, instead of acquiring the scheduling result information from the communication control unit 31 of each of the base stations 30, the optical transmission control unit 11 of the optical transmission device 10 may acquire the wireless feedback information successively transmitted from the wireless terminals 40, information regarding a scheduling policy established at the time of connection, and the traffic flow information.

Then, the optical transmission control unit 11 may perform scheduling on the basis of the acquired wireless feedback information, information regarding a scheduling policy, and traffic flow information. Note that the scheduling policy here includes, for example, round-robin, proportional fair, throughput maximization, and the like.

Note that each of the base stations 30 may be, for example, a Wi-Fi (registered trademark) access point. The signal transmission system 1 is not necessarily a mobile communication system, and may be a wireless communication system other than the mobile communication system.

### [Operation of Signal Transmission System]

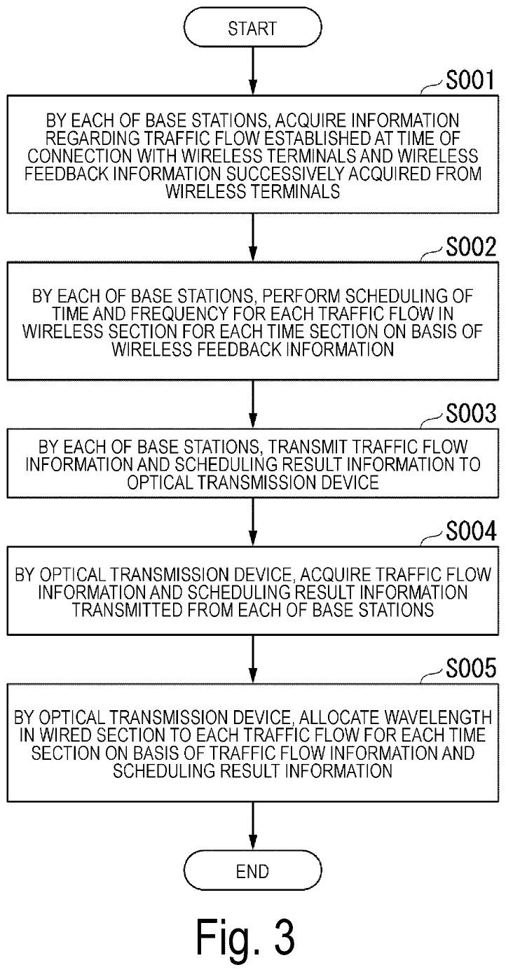

Hereinafter, an example of operation of the signal transmission system 1 will be described. FIG. 3 is a flowchart illustrating operation of the signal transmission system 1 according to the first embodiment of the present invention.

First, each of the base stations 30 acquires information regarding a traffic flow established at the time of connection with the wireless terminals 40 and wireless feedback information successively transmitted from the wireless terminals 40 (step S001).

Next, each of the base stations 30 performs scheduling of time and frequency for each traffic flow in the wireless section for each time section on the basis of the wireless feedback information (step S002).

Next, the communication control unit 31 of each of the base stations 30 transmits traffic flow information and scheduling result information to the optical transmission control unit 11 of the optical transmission device 10 (step S003).

Next, the optical transmission control unit 11 of the optical transmission device 10 acquires the traffic flow information and the scheduling result information transmitted from the communication control unit 31 of each of the base stations 30 (step S004).

Next, on the basis of the acquired traffic flow information and scheduling result information, the optical transmission control unit 11 of the optical transmission device 10 divides a time section and allocates a wavelength used in the wired section (that is, wavelength used between the server 20 and the optical transmission device 10 and wavelength used between the optical transmission device 10 and each of the base stations 30) to each traffic flow for each of the base stations 30 (step S005). Thus, the operation of the signal transmission system 1 illustrated in the flowchart of FIG. 3 ends.

As described above, in the signal transmission system 1 according to the first embodiment of the present invention, similarly to the conventional signal transmission system 6, each of the base stations 30 performs scheduling of time and frequency in the wireless section. Then, the communication control unit 31 of each of the base stations 30 transmits scheduling result information indicating a scheduling result (that is, result of resource allocation of time and frequency for each of traffic flows in the wireless section) and traffic flow information indicating the state of the traffic flows in the wireless section (for example, number of wireless terminals, identifiers for respective traffics, and the like) to the optical transmission control unit 11 of the optical transmission device 10. Then, the optical transmission control unit 11 of the optical transmission device 10 allocates a plurality of wavelengths to the respective traffic flows for the wired section on the basis of the acquired traffic flow information and scheduling result information.

With such a configuration, the signal transmission system 1 according to the first embodiment can transmit a plurality of traffic flows in parallel by wavelength division multiplexing even in the wired section between the server 20 and the base stations 30. As a result, the signal transmission system 1 can reduce occurrence of a delay caused by signal serialization by time division multiplexing, which occurs in the wired section of the conventional signal transmission system 6.

Furthermore, in a conventional mobile communication system such as the signal transmission system 6 described above, in a case where a plurality of wavelengths is allocated in one base station, a wavelength corresponding to a traffic flow to which a frequency resource is not allocated in a wireless section of a certain time section is wasted. As a result, excessive wavelength allocation occurs, and the utilization efficiency of wavelengths decreases.

On the other hand, in the signal transmission system 1 according to the first embodiment described above, the optical transmission device 10 allocates only a wavelength corresponding to a traffic flow to which a frequency resource is allocated in the wireless section for each time section. As a result, the number of wavelengths used is reduced, and the utilization efficiency of wavelengths is improved.

### Second Embodiment

Hereinafter, a signal transmission system 1a according to a second embodiment of the present invention will be described with reference to the drawings.

The signal transmission system 1 according to the first embodiment described above is a mobile communication system in which the wireless terminals 40 and the server 20 mutually transmit a plurality of traffic flows to each other via the base stations 30 and the optical transmission device 10. In the signal transmission system 1 according to the first embodiment, the section between the wireless terminals 40 and the base stations 30 is the wireless section in which wireless signal transmission is performed, and the section between the base stations 30 and the server 20 is the wired section in which wired signal transmission is performed.

On the other hand, the signal transmission system 1a according to the second embodiment described below includes a base station including a central station 20a and a plurality of distributed stations 30a described below. The base station accommodates a plurality of wireless terminals 40. An optical transmission device 10 is included in signal transmission paths between the central station 20a and the distributed stations 30a. The optical transmission device 10a is a transfer device that transmits signals mutually transmitted between the central station 20a and the wireless terminals 40.

The signal transmission system 1a according to the second embodiment is a mobile communication system in which the wireless terminals 40 and the central station 20a mutually transmit a plurality of traffic flows to each other via the distributed stations 30a and the optical transmission device 10. In the signal transmission system 1a according to the second embodiment, a section between the wireless terminals 40 and the distributed stations 30a is a wireless section in which wireless signal transmission is performed, and a section between the distributed stations 30a and the central station 20a is a wired section in which wired signal transmission is performed.

For example, a plurality of distributed stations 30a and the central station 20a according to the second embodiment are a plurality of distributed units (DUs) and a central unit (CU) in a mobile communication system. In this case, a section between the CU and the DUs where the optical transmission device 10 is installed is referred to as a mobile midhaul (MMH). Furthermore, for example, the plurality of distributed stations 30a and the central station 20a according to the second embodiment may be a plurality of radio units (RUs) and a DU in a mobile communication system. In this case, a section between the DU and the RUs where the optical transmission device 10 is installed is referred to as a mobile fronthaul (MFH).

In the signal transmission system 1a according to the second embodiment described below, each of the distributed stations 30a described below performs scheduling of time and frequency in the wireless section. Then, each of the distributed stations 30a transmits a control signal indicating the scheduling result (for example, result of resource allocation of time and frequency or the like) and the state of traffic flows in the wireless section (for example, number of wireless terminals, identifiers for respective traffics, or the like) to the optical transmission device 10 described below.

Then, the optical transmission device 10 allocates a plurality of wavelengths to the respective traffic flows for the wired section according to the acquired state of the traffic flows and scheduling result. As described above, in the conventional signal transmission system 6 described above, a signal is transmitted by time division multiplexing using one wavelength in the wired section, whereas in the signal transmission system 1a according to the second embodiment described below, a signal is transmitted by wavelength division multiplexing using a plurality of wavelengths in the wired section.

### [Configuration of Signal Transmission System]

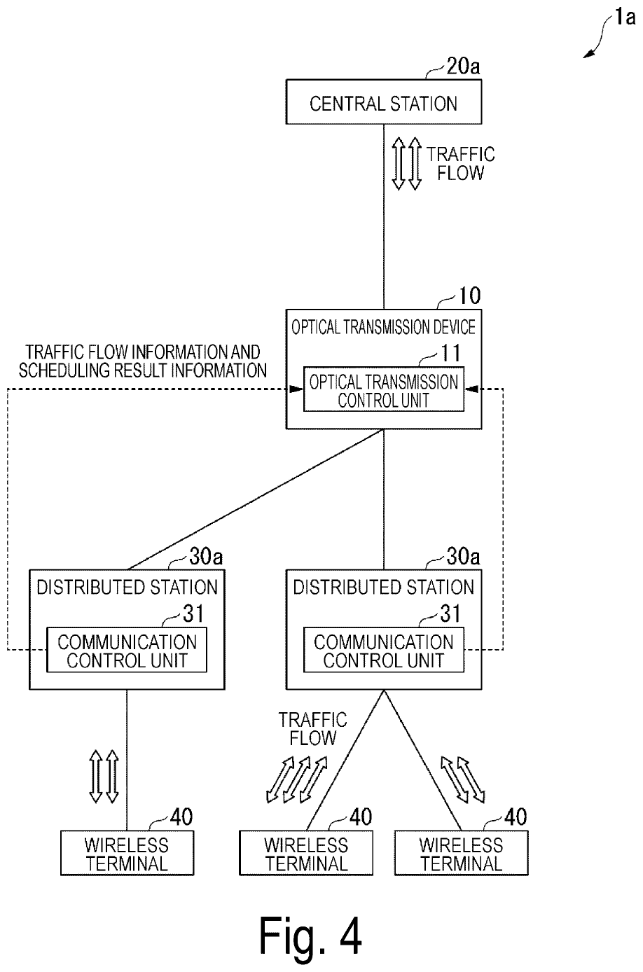

FIG. 4 is a block diagram illustrating an overall configuration of the signal transmission system 1a according to the second embodiment of the present invention. Hereinafter, in a case where a configuration of the signal transmission system 1a according to the second embodiment is similar to the configuration of the signal transmission system 1 according to the first embodiment described above, the description thereof may be omitted.

As illustrated in FIG. 4, the signal transmission system 1a includes the optical transmission device 10, the central station 20a, a plurality of the distributed stations 30a, and a plurality of wireless terminals 40. Note that in FIG. 4, as an example, two distributed stations 30a and three wireless terminals 40 are illustrated, but the number of distributed stations 30a and the number of wireless terminals 40 may be any number.

The optical transmission device 10 is included in signal transmission paths between the central station 20a and the distributed stations 30a. The optical transmission device 10 is a transfer device that transmits signals mutually transmitted between the central station 20a and the wireless terminals 40.

The central station 20a is a communication device that mutually performs transmission of a plurality of traffic flows with the plurality of wireless terminals 40 via the optical transmission device 10 and the distributed stations 30a. Each of the wireless terminals 40 is a communication device that mutually performs transmission of a plurality of traffic flows with the central station 20a via the distributed station 30a and the optical transmission device 10.

Each of the distributed stations 30a is a communication device that mutually performs wireless signal transmission with the wireless terminals 40 and mutually performs wired signal (optical signal) transmission with the optical transmission device 10. Each of the distributed stations 30a transmits signals received from the wireless terminals 40 to the optical transmission device 10, and transmits a signal received from the optical transmission device 10 to the wireless terminals 40.

As described above, the signal transmission system 1a is a mobile communication system in which the wireless terminals 40 and the central station 20a mutually transmit a plurality of traffic flows to each other via the distributed stations 30a and the optical transmission device 10. In the signal transmission system 1a, a section between the wireless terminals 40 and the distributed stations 30a is a wireless section in which wireless signal transmission is performed. On the other hand, a section between the distributed stations 30a and the central station 20a is a wired section in which wired signal transmission is performed.

In the signal transmission system 1a, an identifier of a network class such as NSSAI or an identifier of a QoS class such as 5QI is given to each traffic flow.

As illustrated in FIG. 4, the optical transmission device 10 includes an optical transmission control unit 11. Furthermore, each of the distributed stations 30a includes a communication control unit 31. The communication control unit 31 of each of the distributed stations 30a transmits traffic flow information and scheduling result information to the optical transmission control unit 11 of the optical transmission device 10.

The traffic flow information here is information regarding a traffic flow established at the time of connection between the distributed station 30a and the wireless terminal 40. Specifically, the traffic flow information is, for example, an ID for identifying the wireless terminal 40, an ID for identifying a traffic flow, an identifier for identifying a QoS class, an identifier for identifying a network slice, or the like.

Alternatively, in a case where the plurality of distributed stations 30a and the central station 20a are a plurality of radio units (RUs) and a DU in a mobile communication system, the traffic flow information may be, for example, a slot ID, a symbol ID, a resource block ID, or a layer number of multiple input multiple output (MIMO).

Furthermore, the scheduling result information here is information indicating a result obtained by the distributed station 30a performing scheduling of time and frequency for each traffic flow in the wireless section for each time section on the basis of wireless feedback information successively transmitted from the wireless terminals 40. Specifically, the wireless feedback information is, for example, information indicating the remaining amount of a buffer for each traffic flow in the wireless terminal 40, information indicating the quality of a wireless channel, or the like.

The optical transmission control unit 11 of the optical transmission device 10 acquires the traffic flow information and the scheduling result information transmitted from the communication control unit 31 of each of the distributed stations 30a. On the basis of the acquired traffic flow information and scheduling result information, the optical transmission control unit 11 divides a time section and allocates a wavelength used in the wired section (that is, wavelength used between the central station 20a and the optical transmission device 10 and wavelength used between the optical transmission device 10 and each of the distributed stations 30a) to each traffic flow for each of the distributed stations 30a.

Note that the above-described wavelength allocation may be performed for each of the wireless terminals 40. Alternatively, the above-described wavelength allocation may be performed for each identifier of a QoS class of a traffic flow or for each identifier of a network slice. Note that the above-described wavelength allocation may be performed for each subcarrier of an optical OFDM signal. Note that the above-described wavelength allocation may be allocated for each slot ID, for each symbol ID, for each resource block ID, or for each layer number of MIMO.

Note that each of the distributed stations 30a may include, for example, a wavelength tunable transceiver (not illustrated), and a wavelength allocated by the optical transmission control unit 11 may be used both between the distributed stations 30a and the optical transmission device 10 and between the optical transmission device 10 and the central station 20a. Alternatively, the wavelength allocated by the optical transmission control unit 11 may be used only between the optical transmission device 10 and the central station 20a, and a signal may be transmitted by time division multiplexing using one wavelength between the distributed stations 30a and the optical transmission device 10, similarly to the signal transmission system 6 illustrated in FIG. 1 described above.

Note that, instead of the distributed stations 30a, the optical transmission control unit 11 of the optical transmission device 10 may perform scheduling in the wireless section described above. That is, instead of acquiring the scheduling result information from the communication control unit 31 of each of the distributed stations 30a, the optical transmission control unit 11 of the optical transmission device 10 may acquire the wireless feedback information successively transmitted from the wireless terminals 40, information regarding a scheduling policy established at the time of connection, and the traffic flow information.

Then, the optical transmission control unit 11 may perform scheduling on the basis of the acquired wireless feedback information, information regarding a scheduling policy, and traffic flow information. Note that the scheduling policy here includes, for example, round-robin, proportional fair, throughput maximization, and the like.

Note that the central station 20a may be, for example, a Wi-Fi (registered trademark) controller, and each of the distributed stations 30a may be, for example, a Wi-Fi (registered trademark) access point. The signal transmission system 1a is not necessarily a mobile communication system, and may be a wireless communication system other than the mobile communication system.

As described above, in the signal transmission system 1a according to the second embodiment of the present invention, each of the distributed stations 30a performs scheduling of time and frequency in the wireless section. Then, the communication control unit 31 of each of the distributed stations 30a transmits scheduling result information indicating a scheduling result (that is, result of resource allocation of time and frequency for each of traffic flows in the wireless section) and traffic flow information indicating the state of the traffic flows in the wireless section (for example, number of wireless terminals, identifiers for respective traffics, or the like) to the optical transmission control unit 11 of the optical transmission device 10. Then, the optical transmission control unit 11 of the optical transmission device 10 allocates a plurality of wavelengths to the respective traffic flows for the wired section on the basis of the acquired traffic flow information and scheduling result information.

With such a configuration, the signal transmission system 1a according to the second embodiment can transmit a plurality of traffic flows in parallel by wavelength division multiplexing even in the wired section between the central station 20a and the distributed stations 30a. As a result, the signal transmission system 1a can reduce occurrence of a delay caused by signal serialization by time division multiplexing, which occurs in the wired section of the conventional signal transmission system 6.

Furthermore, in a conventional mobile communication system such as the signal transmission system 6 described above, in a case where a plurality of wavelengths is allocated in one base station, a wavelength corresponding to a traffic flow to which a frequency resource is not allocated in a wireless section of a certain time section is wasted. As a result, excessive wavelength allocation occurs, and the utilization efficiency of wavelengths decreases.

On the other hand, in the signal transmission system 1a according to the second embodiment described above, the optical transmission device 10 allocates only a wavelength corresponding to a traffic flow to which a frequency resource is allocated in the wireless section for each time section. As a result, the number of wavelengths used is reduced, and the utilization efficiency of wavelengths is improved.

### Third Embodiment

Hereinafter, a signal transmission system 1b according to a third embodiment of the present invention will be described with reference to the drawings.

In the signal transmission system 1a according to the second embodiment described above, each of the distributed stations 30a performs scheduling of time and frequency in the wireless section. Then, the communication control unit 31 of each of the distributed stations 30a transmits a control signal indicating the scheduling result (for example, result of resource allocation of time and frequency or the like) and the state of traffic flows in the wireless section (for example, number of wireless terminals, identifiers for respective traffics, or the like) to the optical transmission control unit 11 of the optical transmission device 10.

On the other hand, in the signal transmission system 1b according to the third embodiment described below, a communication control unit 21 is included in a central station 20b described below instead of distributed stations 30b described below. In the signal transmission system 1b according to the third embodiment, the central station 20b performs scheduling of time and frequency in a wireless section. Then, the communication control unit 21 of the central station 20b transmits a control signal indicating the scheduling result (for example, result of resource allocation of time and frequency or the like) and the state of traffic flows in the wireless section (for example, number of wireless terminals, identifiers for respective traffics, or the like) to an optical transmission control unit 11 of an optical transmission device 10.

Then, the optical transmission device 10 allocates a plurality of wavelengths to the respective traffic flows for a wired section according to the acquired state of the traffic flows and scheduling result. As described above, in the conventional signal transmission system 6 described above, a signal is transmitted by time division multiplexing using one wavelength in the wired section, whereas in the signal transmission system 1b according to the third embodiment described below, a signal is transmitted by wavelength division multiplexing using a plurality of wavelengths in the wired section.

### [Configuration of Signal Transmission System]

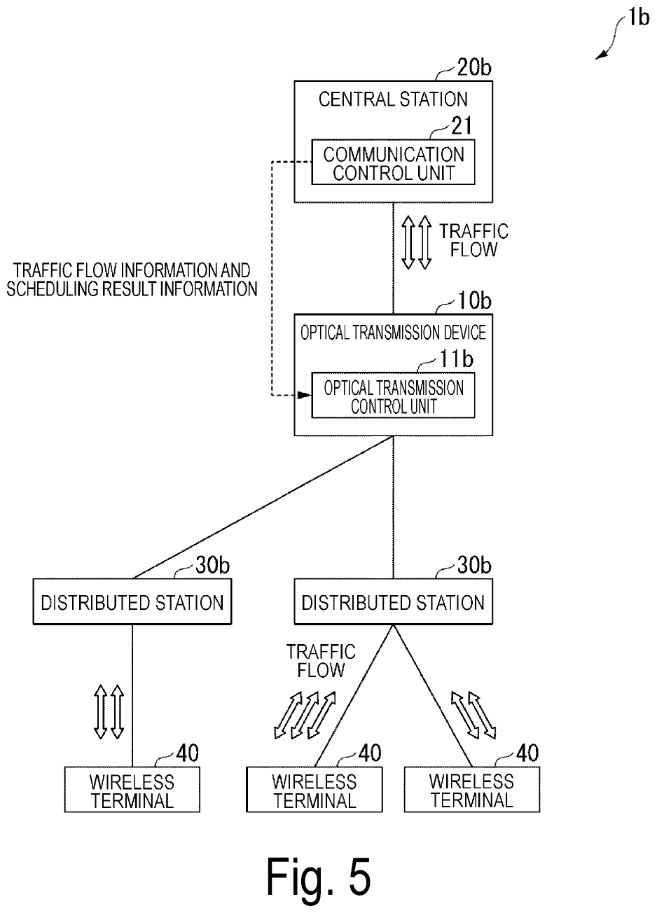

FIG. 5 is a block diagram illustrating an overall configuration of the signal transmission system 1b according to the third embodiment of the present invention. Hereinafter, in a case where a configuration of the signal transmission system 1b according to the third embodiment is similar to the configuration of the signal transmission system 1a according to the second embodiment described above, the description thereof may be omitted.

As illustrated in FIG. 5, the signal transmission system 1b includes the optical transmission device 10, the central station 20b, a plurality of the distributed stations 30b, and a plurality of wireless terminals 40. Note that in FIG. 5, as an example, two distributed stations 30b and three wireless terminals 40 are illustrated, but the number of distributed stations 30b and the number of wireless terminals 40 may be any number.

The optical transmission device 10 is included in signal transmission paths between the central station 20b and the distributed stations 30b. The optical transmission device 10 is a transfer device that transmits signals mutually transmitted between the central station 20b and the wireless terminals 40.

The central station 20b is a communication device that mutually performs transmission of a plurality of traffic flows with the plurality of wireless terminals 40 via the optical transmission device 10 and the distributed stations 30b. Each of the wireless terminals 40 is a communication device that mutually performs transmission of a plurality of traffic flows with the central station 20b via the distributed station 30b and the optical transmission device 10.

Each of the distributed stations 30b is a communication device that mutually performs wireless signal transmission with the wireless terminals 40 and mutually performs wired signal (optical signal) transmission with the optical transmission device 10. Each of the distributed stations 30b transmits signals received from the wireless terminals 40 to the optical transmission device 10, and transmits a signal received from the optical transmission device 10 to the wireless terminals 40.

As described above, the signal transmission system 1b is a mobile communication system in which the wireless terminals 40 and the central station 20b mutually transmit a plurality of traffic flows to each other via the distributed stations 30b and the optical transmission device 10. In the signal transmission system 1b, a section between the wireless terminals 40 and the distributed stations 30b is a wireless section in which wireless signal transmission is performed. On the other hand, a section between the distributed stations 30b and the central station 20b is a wired section in which wired signal transmission is performed.

In the signal transmission system 1b, an identifier of a network class such as NSSAI or an identifier of a QoS class such as 5QI is given to each traffic flow.

As illustrated in FIG. 5, the optical transmission device 10 includes an optical transmission control unit 11. Furthermore, the central station 20b includes a communication control unit 21. The communication control unit 21 of the central station 20b transmits traffic flow information and scheduling result information to the optical transmission control unit 11 of the optical transmission device 10.

The traffic flow information here is information regarding a traffic flow established at the time of connection between the distributed station 30b and the wireless terminal 40. Specifically, the traffic flow information is, for example, an ID for identifying the wireless terminal 40, an ID for identifying a traffic flow, an identifier for identifying a QoS class, an identifier for identifying a network slice, or the like.

Alternatively, in a case where the plurality of distributed stations 30b and the central station 20b are a plurality of RUs and a DU in a mobile communication system, the traffic flow information may be, for example, a slot ID, a symbol ID, a resource block ID, or a layer number of MIMO.

Furthermore, the scheduling result information here is information indicating a result obtained by the central station 20b performing scheduling of time and frequency for each traffic flow in the wireless section for each time section on the basis of wireless feedback information successively transmitted from the wireless terminals 40. Specifically, the wireless feedback information is, for example, information indicating the remaining amount of a buffer for each traffic flow in the wireless terminal 40, information indicating the quality of a wireless channel, or the like.

The optical transmission control unit 11 of the optical transmission device 10 acquires the traffic flow information and the scheduling result information transmitted from the communication control unit 21 of the central station 20b. On the basis of the acquired traffic flow information and scheduling result information, the optical transmission control unit 11 divides a time section and allocates a wavelength used in the wired section (that is, wavelength used between the central station 20b and the optical transmission device 10 and wavelength used between the optical transmission device 10 and each of the distributed stations 30b) to each traffic flow for each of the distributed stations 30b.

Note that the above-described wavelength allocation may be performed for each of the wireless terminals 40. Alternatively, the above-described wavelength allocation may be performed for each identifier of a QoS class of a traffic flow or for each identifier of a network slice. Note that the above-described wavelength allocation may be performed for each subcarrier of an optical OFDM signal.

Note that each of the distributed stations 30b may include, for example, a wavelength tunable transceiver (not illustrated), and a wavelength allocated by the optical transmission control unit 11 may be used both between the distributed stations 30b and the optical transmission device 10 and between the optical transmission device 10 and the central station 20b. Alternatively, the wavelength allocated by the optical transmission control unit 11 may be used only between the optical transmission device 10 and the central station 20b, and a signal may be transmitted by time division multiplexing using one wavelength between the distributed stations 30b and the optical transmission device 10, similarly to the signal transmission system 6 illustrated in FIG. 1 described above.

Note that the central station 20b may be, for example, a Wi-Fi (registered trademark) controller, and each of the distributed stations 30b may be, for example, a Wi-Fi (registered trademark) access point. The signal transmission system 1b is not necessarily a mobile communication system, and may be a wireless communication system other than the mobile communication system.

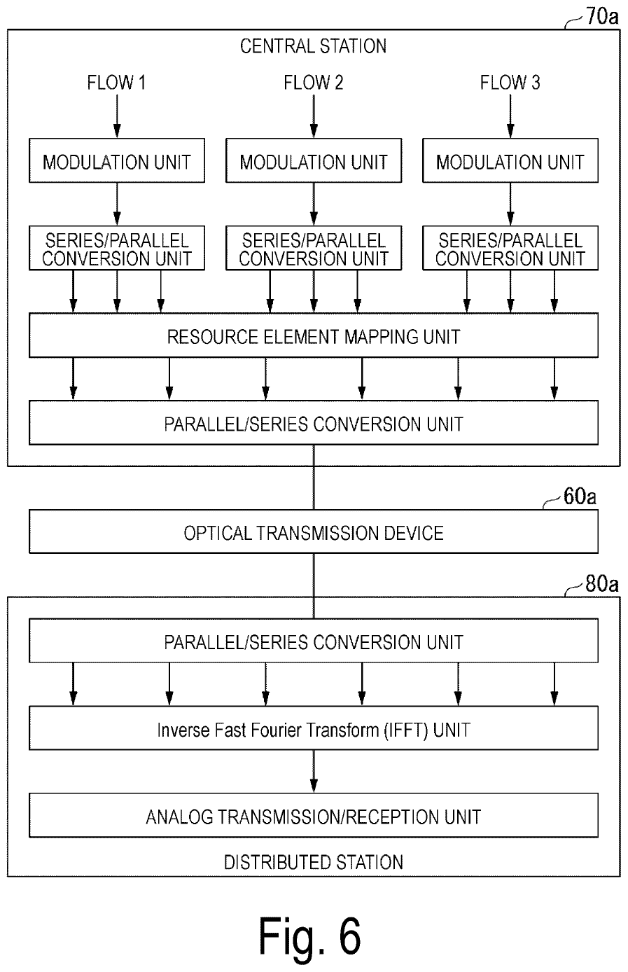

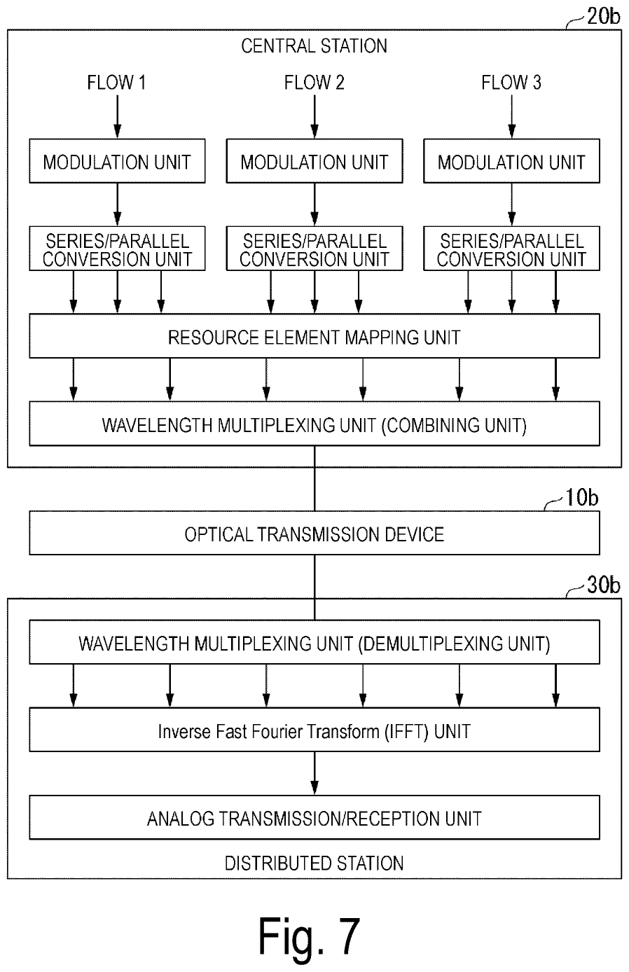

Hereinafter, an image of solving issues by the signal transmission system 1b according to the third embodiment will be described with reference to FIGS. 6 and 7. Here, an example of an image of reducing a delay in the downlink between the DU (central station 20b) and the RUs (distributed stations 30b) and improving wavelength utilization efficiency will be described.

FIG. 6 is a schematic diagram illustrating an example of a configuration of downlink signal transmission by a signal transmission system in a conventional technology. In FIG. 6, only an optical transmission device 60a, a central station 70a, and a distributed station 80a in the conventional signal transmission system are excerpted and illustrated.

As illustrated in FIG. 6, the central station 70a includes modulation units and series/parallel conversion units for respective traffic flows, a resource element mapping unit, and a parallel/series conversion unit. Note that, in FIG. 6, only three traffic flows of flows 1 to 3 are illustrated.

The resource element mapping unit of the central station 70a allocates resources of time and frequency to respective traffic flows output from each of the series/parallel conversion units. Each of the parallel/series conversion units of the central station 70a converts a plurality of traffic flows transmitted in parallel into series, and transmits signals in series by time division multiplexing.

As illustrated in FIG. 6, the distributed station 80a includes a series/parallel conversion unit, an Inverse Fast Fourier Transform (IFFT) unit, and an analog transmission/reception unit.

The series/parallel conversion unit of the distributed station 80a receives a time-division multiplexed signal and converts a plurality of traffic flows transmitted in series into parallel. The Inverse Fast Fourier Transform (IFFT) unit of the distributed station 80a performs modulation by performing inverse fast Fourier transform on the converted signal.

FIG. 7 is a schematic diagram illustrating an example of a configuration of downlink signal transmission by the signal transmission system 1b according to the third embodiment. In FIG. 7, only an optical transmission device 10b, the central station 20b, and the distributed station 30b in the signal transmission system 1b are excerpted and illustrated.

As illustrated in FIG. 7, the central station 20b includes modulation units and series/parallel conversion units for respective traffic flows, a resource element mapping unit, and a wavelength multiplexing unit (combining unit). Note that, in FIG. 7, only three traffic flows of flows 1 to 3 are illustrated.

The resource element mapping unit of the central station 20b allocates resources of time and frequency to respective traffic flows output from each of the series/parallel conversion units. The wavelength multiplexing unit (combining unit) of the central station 20b allocates a wavelength to each of a plurality of traffic flows transmitted in parallel and multiplexes the traffic flows, and transmits signals in parallel by wavelength division multiplexing.

As illustrated in FIG. 7, the distributed station 30b includes a wavelength multiplexing unit (demultiplexing unit), an IFFT unit, and an analog transmission/reception unit.

The wavelength multiplexing unit (demultiplexing unit) of the distributed station 30b receives and demultiplexes a signal obtained by performing wavelength division multiplexing on a plurality of traffic flows and transmitting the traffic flows in parallel. The Inverse Fast Fourier Transform (IFFT) unit of the distributed station 30b performs modulation by performing inverse fast Fourier transform on the demultiplexed signal.

As can be seen from a comparison between FIG. 6 and FIG. 7, the series/parallel conversion units included in the central station 70a and the distributed station 80a of the signal transmission system in the conventional technology are respectively replaced with the wavelength multiplexing unit (combining unit) and the wavelength multiplexing unit (demultiplexing unit) in the signal transmission system 1b according to the third embodiment. With such a configuration, the signal transmission system 1b according to the third embodiment can transmit a plurality of traffic flows in parallel by wavelength division multiplexing even in the wired section between the central station 20b and the distributed stations 30b.

As described above, in the signal transmission system 1b according to the third embodiment of the present invention, the central station 20b performs scheduling of time and frequency in the wireless section. Then, the communication control unit 21 of the central station 20b transmits scheduling result information indicating a scheduling result (that is, result of resource allocation of time and frequency for each of traffic flows in the wireless section) and traffic flow information indicating the state of the traffic flows in the wireless section (for example, number of wireless terminals, identifiers for respective traffics, or the like) to the optical transmission control unit 11 of the optical transmission device 10. Then, the optical transmission control unit 11 of the optical transmission device 10 allocates a plurality of wavelengths to the respective traffic flows for the wired section on the basis of the acquired traffic flow information and scheduling result information.

With such a configuration, the signal transmission system 1b according to the third embodiment can transmit a plurality of traffic flows in parallel by wavelength division multiplexing even in the wired section between the central station 20b and the distributed stations 30b. As a result, the signal transmission system 1b can reduce occurrence of a delay caused by signal serialization by time division multiplexing, which occurs in the wired section of the conventional signal transmission system 6.

Furthermore, in a conventional mobile communication system such as the signal transmission system 6 described above, in a case where a plurality of wavelengths is allocated in one base station, a wavelength corresponding to a traffic flow to which a frequency resource is not allocated in a wireless section of a certain time section is wasted. As a result, excessive wavelength allocation occurs, and the utilization efficiency of wavelengths decreases.

On the other hand, in the signal transmission system 1b according to the third embodiment described above, the optical transmission device 10 allocates only a wavelength corresponding to a traffic flow to which a frequency resource is allocated in the wireless section for each time section. As a result, the number of wavelengths used is reduced, and the utilization efficiency of wavelengths is improved.

### Fourth Embodiment

Hereinafter, a signal transmission system 1c according to a fourth embodiment of the present invention will be described with reference to the drawings.

In the signal transmission system 1 according to the first embodiment described above, traffic flow information and scheduling result information are directly transmitted from the communication control unit 31 of each of the base stations 30 to the optical transmission control unit 11 of the optical transmission device 10.

On the other hand, the signal transmission system 1c according to the fourth embodiment described below further includes a wireless controller 50 that controls base stations 30c described below and an optical transmission device controller 55 that controls an optical transmission device 10c described below. Then, in the signal transmission system 1c according to the fourth embodiment, the wireless controller 50 collects traffic flow information and scheduling result information from each of communication control units 31 of a plurality of the base stations 30c and transmits the traffic flow information and the scheduling result information to the optical transmission device controller 55. Then, the optical transmission device controller 55 allocates a wavelength used in a wired section for each traffic flow on the basis of the traffic flow information and the scheduling result information.

### [Configuration of Signal Transmission System]

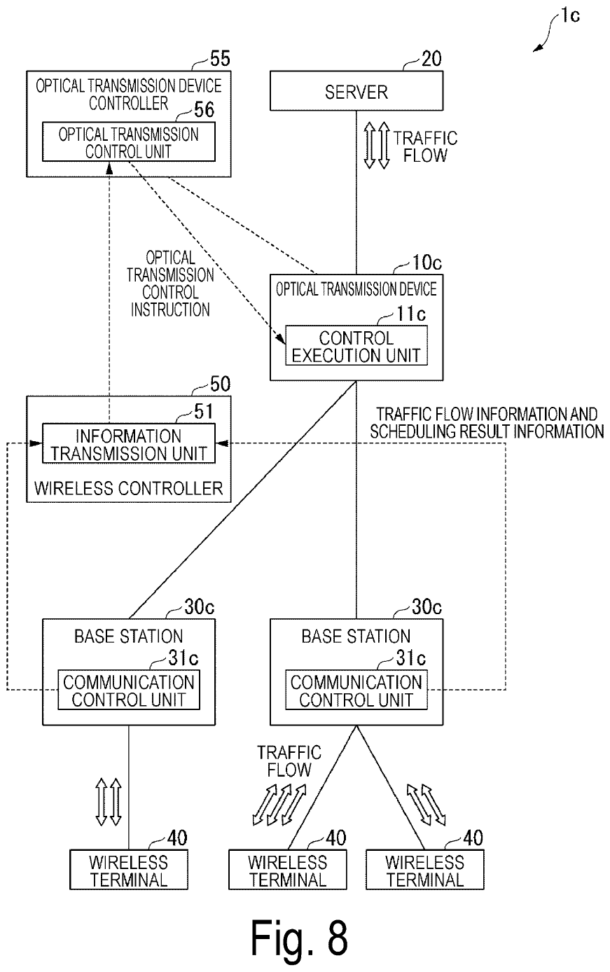

FIG. 8 is a block diagram illustrating an overall configuration of the signal transmission system 1c according to the fourth embodiment of the present invention. As illustrated in FIG. 8, the signal transmission system 1c includes the optical transmission device 10c, a server 20, a plurality of the base stations 30c, a plurality of wireless terminals 40, the wireless controller 50, and the optical transmission device controller 55. Note that in FIG. 8, as an example, two base stations 30c and three wireless terminals 40 are illustrated, but the number of base stations 30c and the number of wireless terminals 40 may be any number.

The optical transmission device 10c is included in signal transmission paths between the server 20 and the base stations 30c. The optical transmission device 10c is a transfer device that transmits signals mutually transmitted between the server 20 and the wireless terminals 40.

The server 20 is a communication device that mutually performs transmission of a plurality of traffic flows with a plurality of wireless terminals 40 via the optical transmission device 10c and the base stations 30c. Each of the wireless terminals 40 is a communication device that mutually performs transmission of a plurality of traffic flows with the server 20 via the base station 30c and the optical transmission device 10c.

Each of the base stations 30c accommodates a plurality of wireless terminals 40. Each of the base stations 30c is a communication device that mutually performs wireless signal transmission with the wireless terminals 40 and mutually performs wired signal (optical signal) transmission with the optical transmission device 10c. Each of the base stations 30c transmits signals received from the wireless terminals 40 to the optical transmission device 10c, and transmits a signal received from the optical transmission device 10c to the wireless terminals 40.

As described above, the signal transmission system 1c is a mobile communication system in which the wireless terminals 40 and the server 20 mutually transmit a plurality of traffic flows to each other via the base stations 30c and the optical transmission device 10c. In the signal transmission system 1c, a section between the wireless terminals 40 and the base stations 30c is a wireless section in which wireless signal transmission is performed. On the other hand, a section between the base stations 30c and the server 20 is a wired section in which wired signal transmission is performed.

In the signal transmission system 1c, an identifier of a network class such as NSSAI or an identifier of a QoS class such as 5QI is given to each traffic flow.

As illustrated in FIG. 8, the optical transmission device 10c includes a control execution unit 11c. Furthermore, each of the base stations 30c includes a communication control unit 31c. The wireless controller 50 includes an information transmission unit 51. The optical transmission device controller 55 includes an optical transmission control unit 56.

The communication control unit 31c of each of the base stations 30c transmits traffic flow information and scheduling result information to the information transmission unit 51 of the wireless controller 50.

The traffic flow information here is information regarding a traffic flow established at the time of connection between the base station 30c and the wireless terminal 40. Specifically, the traffic flow information is, for example, an ID for identifying the wireless terminal 40, an ID for identifying a traffic flow, an identifier for identifying a QoS class, an identifier for identifying a network slice, or the like. Furthermore, the scheduling result information here is information indicating a result obtained by the base station 30c performing scheduling of time and frequency for each traffic flow in the wireless section for each time section on the basis of wireless feedback information successively transmitted from the wireless terminals 40. Specifically, the wireless feedback information is, for example, information indicating the remaining amount of a buffer for each traffic flow in the wireless terminal 40, information indicating the quality of a wireless channel, or the like.

The information transmission unit 51 of the wireless controller 50 acquires the traffic flow information and the scheduling result information transmitted from the communication control unit 31c of each of the base stations 30c. The information transmission unit 51 transmits the traffic flow information and the scheduling result information collected from each of the base stations 30c to the optical transmission control unit 56 of the optical transmission device controller 55.

The optical transmission control unit 56 of the optical transmission device controller 55 acquires the traffic flow information and the scheduling result information transmitted from the information transmission unit 51 of the wireless controller 50. On the basis of the acquired traffic flow information and scheduling result information, the optical transmission control unit 56 divides a time section and allocates a wavelength used in the wired section (that is, wavelength used between the server 20 and the optical transmission device 10c and wavelength used between the optical transmission device 10c and each of the base stations 30c) to each traffic flow for each of the base stations 30c.

The optical transmission control unit 56 transmits an optical transmission control instruction including information indicating a result of wavelength allocation to the control execution unit 11c of the optical transmission device 10c. The control execution unit 11c of the optical transmission device 10c controls the wavelength for each traffic flow according to the result of wavelength allocation based on the acquired optical transmission control instruction.

Note that the above-described wavelength allocation may be performed for each of the wireless terminals 40. Alternatively, the above-described wavelength allocation may be performed for each identifier of a QoS class of a traffic flow or for each identifier of a network slice. Note that the above-described wavelength allocation may be performed for each subcarrier of an optical OFDM signal.

Note that each of the base stations 30c may include, for example, a wavelength tunable transceiver (not illustrated), and a wavelength allocated by the optical transmission control unit 56 may be used both between the base stations 30c and the optical transmission device 10c and between the optical transmission device 10c and the server 20. Alternatively, the wavelength allocated by the optical transmission control unit 56 may be used only between the optical transmission device 10c and the server 20, and a signal may be transmitted by time division multiplexing using one wavelength between the base stations 30c and the optical transmission device 10c, similarly to the signal transmission system 6 illustrated in FIG. 1 described above.

Note that, instead of the optical transmission device controller 55, the control execution unit 11c of the optical transmission device 10c may perform scheduling in the wireless section described above. That is, instead of acquiring the scheduling result information from the optical transmission control unit 56 of the optical transmission device controller 55, the control execution unit 11c of the optical transmission device 10c may acquire the wireless feedback information successively transmitted from the wireless terminals 40, information regarding a scheduling policy established at the time of connection, and the traffic flow information via the wireless controller 50 and the optical transmission device controller 55.

Then, the control execution unit 11c may perform scheduling on the basis of the acquired wireless feedback information, information regarding a scheduling policy, and traffic flow information. Note that the scheduling policy here includes, for example, round-robin, proportional fair, throughput maximization, and the like.

Note that the wireless controller 50 and the optical transmission device controller 55 may acquire connection information between the server 20 and the wireless terminals 40, such as a network slice or QoS, from a higher-level controller (not illustrated) such as an orchestrator, for example.

Note that each of the base stations 30c may be, for example, a Wi-Fi (registered trademark) access point. The signal transmission system 1c is not necessarily a mobile communication system, and may be a wireless communication system other than the mobile communication system.

As described above, in the signal transmission system 1c according to the fourth embodiment of the present invention, similarly to the conventional signal transmission system 6, each of the base stations 30c performs scheduling of time and frequency in the wireless section. Then, the communication control unit 31c of each of the base stations 30c transmits scheduling result information indicating a scheduling result (that is, result of resource allocation of time and frequency for each of traffic flows in the wireless section) and traffic flow information indicating the state of the traffic flows in the wireless section (for example, number of wireless terminals, identifiers for respective traffics, or the like) to the information transmission unit 51 of the wireless controller 50. The information transmission unit 51 of the wireless controller 50 transmits the traffic flow information and the scheduling result information collected from each of the base stations 30c to the optical transmission control unit 56 of the optical transmission device controller 55. Then, the optical transmission control unit 56 of the optical transmission device controller 55 allocates a plurality of wavelengths to the respective traffic flows for the wired section on the basis of the acquired traffic flow information and scheduling result information.

With such a configuration, the signal transmission system 1c according to the fourth embodiment can transmit a plurality of traffic flows in parallel by wavelength division multiplexing even in the wired section between the server 20 and the base stations 30c. As a result, the signal transmission system 1c can reduce occurrence of a delay caused by signal serialization by time division multiplexing, which occurs in the wired section of the conventional signal transmission system 6.

Furthermore, in a conventional mobile communication system such as the signal transmission system 6 described above, in a case where a plurality of wavelengths is allocated in one base station, a wavelength corresponding to a traffic flow to which a frequency resource is not allocated in a wireless section of a certain time section is wasted. As a result, excessive wavelength allocation occurs, and the utilization efficiency of wavelengths decreases.

On the other hand, in the signal transmission system 1c according to the fourth embodiment described above, the optical transmission device controller 55 allocates only a wavelength corresponding to a traffic flow to which a frequency resource is allocated in the wireless section for each time section. As a result, the number of wavelengths used is reduced, and the utilization efficiency of wavelengths is improved.

### Fifth Embodiment

Hereinafter, a signal transmission system 1d according to a fifth embodiment of the present invention will be described with reference to the drawings.

The signal transmission system 1c according to the fourth embodiment described above is a mobile communication system in which the wireless terminals 40 and the server 20 mutually transmit a plurality of traffic flows to each other via the base stations 30c and the optical transmission device 10c. In the signal transmission system 1c according to the fourth embodiment, the section between the wireless terminals 40 and the base stations 30c is the wireless section in which wireless signal transmission is performed, and the section between the base stations 30c and the server 20 is the wired section in which wired signal transmission is performed.

On the other hand, the signal transmission system 1d according to the fifth embodiment described below includes a base station including a central station 20d and a plurality of distributed stations 30d. The base station accommodates a plurality of wireless terminals 40. An optical transmission device 10d is included in signal transmission paths between the central station 20d and the distributed stations 30d. The optical transmission device 10d is a transfer device that transmits signals mutually transmitted between the central station 20d and the wireless terminals 40.

The signal transmission system 1d according to the fifth embodiment is a mobile communication system in which the wireless terminals 40 and the central station 20d mutually transmit a plurality of traffic flows to each other via the distributed stations 30d and the optical transmission device 10d. In the signal transmission system 1d according to the fifth embodiment, the section between the wireless terminals 40 and the distributed stations 30d is the wireless section in which wireless signal transmission is performed, and the section between the distributed stations 30d and the central station 20d is the wired section in which wired signal transmission is performed.

For example, the plurality of distributed stations 30d and the central station 20d according to the fifth embodiment are a plurality of DUs and a CU in a mobile communication system. In this case, a section between the CU and the DUs where the optical transmission device 10d is installed is a mobile midhaul (MMH). Furthermore, for example, the plurality of distributed stations 30d and the central station 20d according to the fifth embodiment may be a plurality of RUs and a DU in a mobile communication system. In this case, a section between the DU and the RUs where the optical transmission device 10d is installed is a mobile fronthaul (MFH).

In the signal transmission system 1d according to the fifth embodiment described below, each of the distributed stations 30d described below performs scheduling of time and frequency in the wireless section. Then, each of the distributed stations 30d transmits a control signal indicating the scheduling result (for example, result of resource allocation of time and frequency or the like) and the state of traffic flows in the wireless section (for example, number of wireless terminals, identifiers for respective traffics, or the like) to an optical transmission device controller 55 via a wireless controller 50 described below.

Then, the optical transmission device controller 55 allocates a plurality of wavelengths for a wired section for the respective traffic flows according to the acquired state of the traffic flows and scheduling result. As described above, in the conventional signal transmission system 6 described above, a signal is transmitted by time division multiplexing using one wavelength in the wired section, whereas in the signal transmission system 1d according to the fifth embodiment described below, a signal is transmitted by wavelength division multiplexing using a plurality of wavelengths in the wired section.

### [Configuration of Signal Transmission System]

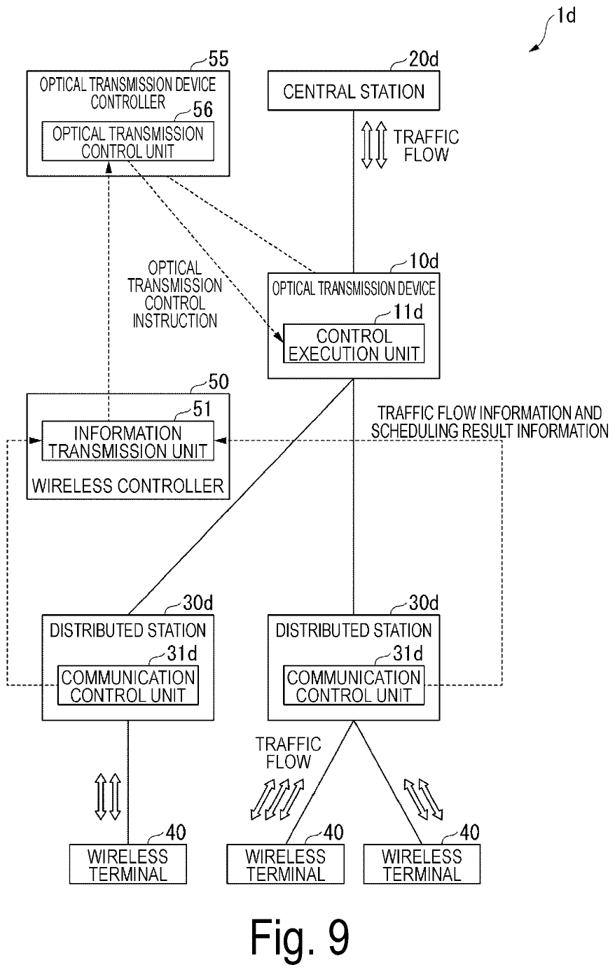

FIG. 9 is a block diagram illustrating an overall configuration of the signal transmission system 1d according to the fifth embodiment of the present invention. Hereinafter, in a case where a configuration of the signal transmission system 1d according to the fifth embodiment is similar to the configuration of the signal transmission system 1c according to the fourth embodiment described above, the description thereof may be omitted.

As illustrated in FIG. 9, the signal transmission system 1d includes the optical transmission device 10d, the central station 20d, a plurality of the distributed stations 30d, a plurality of wireless terminals 40, the wireless controller 50, and the optical transmission device controller 55. Note that in FIG. 9, as an example, two distributed stations 30d and three wireless terminals 40 are illustrated, but the number of distributed stations 30d and the number of wireless terminals 40 may be any number.

The optical transmission device 10d is included in signal transmission paths between the central station 20d and the distributed stations 30d. The optical transmission device 10d is a transfer device that transmits signals mutually transmitted between the central station 20d and the wireless terminals 40.

The central station 20d is a communication device that mutually performs transmission of a plurality of traffic flows with the plurality of wireless terminals 40 via the optical transmission device 10d and the distributed stations 30d. Each of the wireless terminals 40 is a communication device that mutually performs transmission of a plurality of traffic flows with the central station 20d via the distributed station 30d and the optical transmission device 10d.

Each of the distributed stations 30d is a communication device that mutually performs wireless signal transmission with the wireless terminals 40 and mutually performs wired signal (optical signal) transmission with the optical transmission device 10d. Each of the distributed stations 30d transmits signals received from the wireless terminals 40 to the optical transmission device 10d, and transmits a signal received from the optical transmission device 10d to the wireless terminals 40.

As described above, the signal transmission system 1d is a mobile communication system in which the wireless terminals 40 and the central station 20d mutually transmit a plurality of traffic flows to each other via the distributed stations 30d and the optical transmission device 10d. In the signal transmission system 1d, a section between the wireless terminals 40 and the distributed stations 30d is a wireless section in which wireless signal transmission is performed. On the other hand, a section between the distributed stations 30d and the central station 20d is a wired section in which wired signal transmission is performed.

In the signal transmission system 1d, an identifier of a network class such as NSSAI or an identifier of a QoS class such as 5QI is given to each traffic flow.

As illustrated in FIG. 9, the optical transmission device 10d includes a control execution unit 11d. Furthermore, each of the distributed stations 30d includes a communication control unit 31d. The wireless controller 50 includes an information transmission unit 51. The optical transmission device controller 55 includes an optical transmission control unit 56.

The communication control unit 31d of each of the distributed stations 30d transmits traffic flow information and scheduling result information to the information transmission unit 51 of the wireless controller 50.

The traffic flow information here is information regarding a traffic flow established at the time of connection between the distributed station 30d and the wireless terminal 40. Specifically, the traffic flow information is, for example, an ID for identifying the wireless terminal 40, an ID for identifying a traffic flow, an identifier for identifying a QoS class, an identifier for identifying a network slice, or the like.

Alternatively, in a case where the plurality of distributed stations 30d and the central station 20d are a plurality of RUs and a DU in a mobile communication system, the traffic flow information may be, for example, a slot ID, a symbol ID, a resource block ID, or a layer number of MIMO.

Furthermore, the scheduling result information here is information indicating a result obtained by the distributed station 30d performing scheduling of time and frequency for each traffic flow in the wireless section for each time section on the basis of wireless feedback information successively transmitted from the wireless terminals 40. Specifically, the wireless feedback information is, for example, information indicating the remaining amount of a buffer for each traffic flow in the wireless terminal 40, information indicating the quality of a wireless channel, or the like.

The information transmission unit 51 of the wireless controller 50 acquires the traffic flow information and the scheduling result information transmitted from the communication control unit 31d of each of the distributed stations 30d. The information transmission unit 51 transmits the traffic flow information and the scheduling result information collected from each of the distributed stations 30d to the optical transmission control unit 56 of the optical transmission device controller 55.

The optical transmission control unit 56 of the optical transmission device controller 55 acquires the traffic flow information and the scheduling result information transmitted from the information transmission unit 51 of the wireless controller 50. On the basis of the acquired traffic flow information and scheduling result information, the optical transmission control unit 56 divides a time section and allocates a wavelength used in the wired section (that is, wavelength used between the central station 20d and the optical transmission device 10d and wavelength used between the optical transmission device 10d and each of the distributed stations 30d) to each traffic flow for each of the distributed stations 30d.

The optical transmission control unit 56 transmits an optical transmission control instruction including information indicating a result of wavelength allocation to the control execution unit 11d of the optical transmission device 10d. The control execution unit 11d of the optical transmission device 10d controls the wavelength for each traffic flow according to the result of wavelength allocation based on the acquired optical transmission control instruction.

Note that the above-described wavelength allocation may be performed for each of the wireless terminals 40. Alternatively, the above-described wavelength allocation may be performed for each identifier of a QoS class of a traffic flow or for each identifier of a network slice. Note that the above-described wavelength allocation may be performed for each subcarrier of an optical OFDM signal.

Note that each of the distributed stations 30d may include, for example, a wavelength tunable transceiver (not illustrated), and a wavelength allocated by the optical transmission control unit 56 may be used both between the distributed stations 30d and the optical transmission device 10d and between the optical transmission device 10d and the central station 20d. Alternatively, the wavelength allocated by the optical transmission control unit 56 may be used only between the optical transmission device 10d and the central station 20d, and a signal may be transmitted by time division multiplexing using one wavelength between the distributed stations 30d and the optical transmission device 10d, similarly to the signal transmission system 6 illustrated in FIG. 1 described above.

Note that, instead of the optical transmission device controller 55, the control execution unit 11d of the optical transmission device 10d may perform scheduling in the wireless section described above. That is, instead of acquiring the scheduling result information from the optical transmission control unit 56 of the optical transmission device controller 55, the control execution unit 11d of the optical transmission device 10d may acquire the wireless feedback information successively transmitted from the wireless terminals 40, information regarding a scheduling policy established at the time of connection, and the traffic flow information.

Then, the control execution unit 11d may perform scheduling on the basis of the acquired wireless feedback information, information regarding a scheduling policy, and traffic flow information. Note that the scheduling policy here includes, for example, round-robin, proportional fair, throughput maximization, and the like.

Note that the wireless controller 50 and the optical transmission device controller 55 may acquire connection information between the central station 20d and the wireless terminals 40, such as a network slice or QoS, from a higher-level controller (not illustrated) such as an orchestrator, for example.

Note that the central station 20d may be, for example, a Wi-Fi (registered trademark) controller, and each of the distributed stations 30d may be, for example, a Wi-Fi (registered trademark) access point. The signal transmission system 1d is not necessarily a mobile communication system, and may be a wireless communication system other than the mobile communication system.

As described above, in the signal transmission system 1d according to the fifth embodiment of the present invention, each of the distributed stations 30d performs scheduling of time and frequency in the wireless section. Then, the communication control unit 31d of each of the distributed stations 30d transmits scheduling result information indicating a scheduling result (that is, result of resource allocation of time and frequency for each of traffic flows in the wireless section) and traffic flow information indicating the state of the traffic flows in the wireless section (for example, number of wireless terminals, identifiers for respective traffics, or the like) to the information transmission unit 51 of the wireless controller 50. The information transmission unit 51 of the wireless controller 50 transmits the traffic flow information and the scheduling result information collected from each of the distributed stations 30d to the optical transmission control unit 56 of the optical transmission device controller 55. Then, the optical transmission control unit 56 of the optical transmission device controller 55 allocates a plurality of wavelengths to the respective traffic flows for the wired section on the basis of the acquired traffic flow information and scheduling result information.

With such a configuration, the signal transmission system 1d according to the fifth embodiment can transmit a plurality of traffic flows in parallel by wavelength division multiplexing even in the wired section between the central station 20d and the distributed stations 30d. As a result, the signal transmission system 1a can reduce occurrence of a delay caused by signal serialization by time division multiplexing, which occurs in the wired section of the conventional signal transmission system 6.

Furthermore, in a conventional mobile communication system such as the signal transmission system 6 described above, in a case where a plurality of wavelengths is allocated in one base station, a wavelength corresponding to a traffic flow to which a frequency resource is not allocated in a wireless section of a certain time section is wasted. As a result, excessive wavelength allocation occurs, and the utilization efficiency of wavelengths decreases.

On the other hand, in the signal transmission system 1d according to the fifth embodiment described above, the optical transmission device controller 55 allocates only a wavelength corresponding to a traffic flow to which a frequency resource is allocated in the wireless section for each time section. As a result, the number of wavelengths used is reduced, and the utilization efficiency of wavelengths is improved.

### Sixth Embodiment

Hereinafter, a signal transmission system 1e according to a sixth embodiment of the present invention will be described with reference to the drawings.

In the signal transmission system 1d according to the fifth embodiment described above, each of the distributed stations 30d performs scheduling of time and frequency in the wireless section. Then, the communication control unit 31 of each of the distributed stations 30d transmits a control signal indicating the scheduling result (for example, result of resource allocation of time and frequency or the like) and the state of traffic flows in the wireless section (for example, number of wireless terminals, identifiers for respective traffics, or the like) to the optical transmission control unit 56 of the optical transmission device controller 55 via the information transmission unit 51 of the wireless controller 50.

On the other hand, in the signal transmission system 1e according to the sixth embodiment described below, a communication control unit 21e is included in a central station 20e described below instead of distributed stations 30e described below. In the signal transmission system 1e according to the sixth embodiment, the central station 20e performs scheduling of time and frequency in the wireless section. Then, the communication control unit 21 of the central station 20e transmits a control signal indicating the scheduling result (for example, result of resource allocation of time and frequency or the like) and the state of traffic flows in the wireless section (for example, number of wireless terminals, identifiers for respective traffics, or the like) to an optical transmission device controller 55 via a wireless controller 50 described below.

Then, the optical transmission device controller 55 allocates a plurality of wavelengths for a wired section for the respective traffic flows according to the acquired state of the traffic flows and scheduling result. As described above, in the conventional signal transmission system 6 described above, a signal is transmitted by time division multiplexing using one wavelength in the wired section, whereas in the signal transmission system 1e according to the sixth embodiment described below, a signal is transmitted by wavelength division multiplexing using a plurality of wavelengths in the wired section.

### [Configuration of Signal Transmission System]

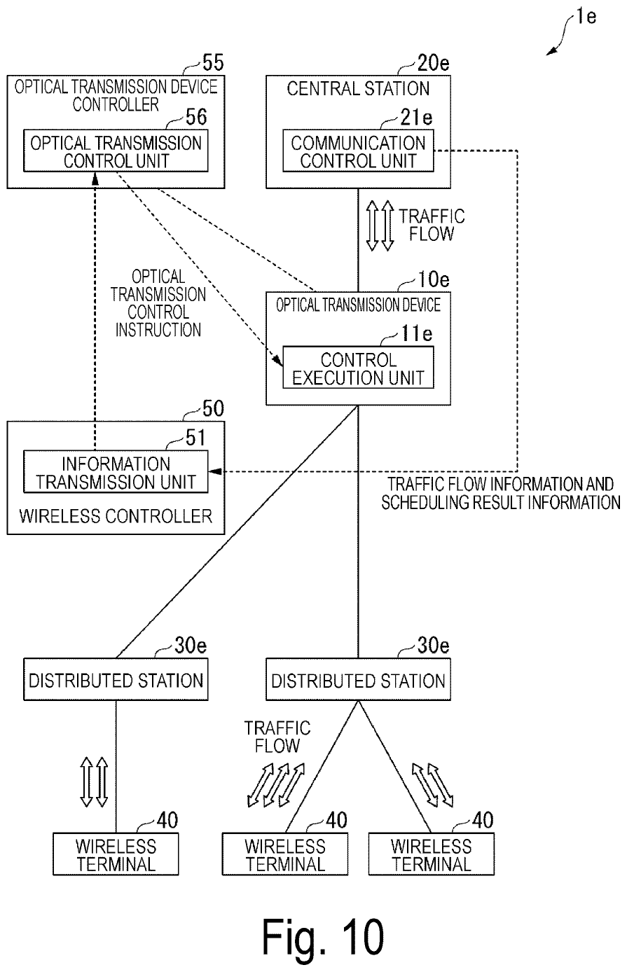

FIG. 10 is a block diagram illustrating an overall configuration of the signal transmission system 1e according to the sixth embodiment of the present invention. Hereinafter, in a case where a configuration of the signal transmission system 1e according to the sixth embodiment is similar to the configuration of the signal transmission system 1d according to the fifth embodiment described above, the description thereof may be omitted.

As illustrated in FIG. 10, the signal transmission system 1e includes an optical transmission device 10e, the central station 20e, a plurality of the distributed stations 30e, a plurality of wireless terminals 40, the wireless controller 50, and the optical transmission device controller 55. Note that in FIG. 10, as an example, two distributed stations 30e and three wireless terminals 40 are illustrated, but the number of distributed stations 30e and the number of wireless terminals 40 may be any number.

The optical transmission device 10e is included in signal transmission paths between the central station 20e and the distributed stations 30e. The optical transmission device 10e is a transfer device that transmits signals mutually transmitted between the central station 20e and the wireless terminals 40.

The central station 20e is a communication device that mutually performs transmission of a plurality of traffic flows with the plurality of wireless terminals 40 via the optical transmission device 10e and the distributed stations 30e. Each of the wireless terminals 40 is a communication device that mutually performs transmission of a plurality of traffic flows with the central station 20e via the distributed station 30e and the optical transmission device 10e.

Each of the distributed stations 30e is a communication device that mutually performs wireless signal transmission with the wireless terminals 40 and mutually performs wired signal (optical signal) transmission with the optical transmission device 10e. Each of the distributed stations 30e transmits signals received from the wireless terminals 40 to the optical transmission device 10e, and transmits a signal received from the optical transmission device 10e to the wireless terminals 40.

As described above, the signal transmission system 1e is a mobile communication system in which the wireless terminals 40 and the central station 20e mutually transmit a plurality of traffic flows to each other via the distributed stations 30e and the optical transmission device 10e. In the signal transmission system 1e, a section between the wireless terminals 40 and the distributed stations 30e is a wireless section in which wireless signal transmission is performed. On the other hand, a section between the distributed stations 30e and the central station 20e is a wired section in which wired signal transmission is performed.

In the signal transmission system 1e, an identifier of a network class such as NSSAI or an identifier of a QoS class such as 5QI is given to each traffic flow.

As illustrated in FIG. 10, the optical transmission device 10e includes a control execution unit 11e. Furthermore, the central station 20e includes a communication control unit 21e. The wireless controller 50 includes an information transmission unit 51. The optical transmission device controller 55 includes an optical transmission control unit 56.

The communication control unit 21e of the central station 20e transmits traffic flow information and scheduling result information to the information transmission unit 51 of the wireless controller 50.

The traffic flow information here is information regarding a traffic flow established at the time of connection between the distributed station 30e and the wireless terminal 40. Specifically, the traffic flow information is, for example, an ID for identifying the wireless terminal 40, an ID for identifying a traffic flow, an identifier for identifying a QoS class, an identifier for identifying a network slice, or the like.

Alternatively, in a case where the plurality of distributed stations 30e and the central station 20e are a plurality of RUs and a DU in a mobile communication system, the traffic flow information may be, for example, a slot ID, a symbol ID, a resource block ID, or a layer number of MIMO.

Furthermore, the scheduling result information here is information indicating a result obtained by the central station 20e performing scheduling of time and frequency for each traffic flow in the wireless section for each time section on the basis of wireless feedback information successively transmitted from the wireless terminals 40. Specifically, the wireless feedback information is, for example, information indicating the remaining amount of a buffer for each traffic flow in the wireless terminal 40, information indicating the quality of a wireless channel, or the like.

The information transmission unit 51 of the wireless controller 50 acquires the traffic flow information and the scheduling result information transmitted from the communication control unit 21e of the central station 20e. The information transmission unit 51 transmits the traffic flow information and the scheduling result information acquired from the central station 20e to the optical transmission control unit 56 of the optical transmission device controller 55.

The optical transmission control unit 56 of the optical transmission device controller 55 acquires the traffic flow information and the scheduling result information transmitted from the information transmission unit 51 of the wireless controller 50. On the basis of the acquired traffic flow information and scheduling result information, the optical transmission control unit 56 divides a time section and allocates a wavelength used in the wired section (that is, wavelength used between the central station 20e and the optical transmission device 10e and wavelength used between the optical transmission device 10e and each of the distributed stations 30e) to each traffic flow for each of the distributed stations 30e.

The optical transmission control unit 56 transmits an optical transmission control instruction including information indicating a result of wavelength allocation to the control execution unit 11e of the optical transmission device 10e. The control execution unit 11e of the optical transmission device 10e controls the wavelength for each traffic flow according to the result of wavelength allocation based on the acquired optical transmission control instruction.

Note that the above-described wavelength allocation may be performed for each of the wireless terminals 40. Alternatively, the above-described wavelength allocation may be performed for each identifier of a QoS class of a traffic flow or for each identifier of a network slice. Note that the above-described wavelength allocation may be performed for each subcarrier of an optical OFDM signal.

Note that each of the distributed stations 30e may include, for example, a wavelength tunable transceiver (not illustrated), and a wavelength allocated by the optical transmission control unit 56 may be used both between the distributed stations 30e and the optical transmission device 10e and between the optical transmission device 10e and the central station 20e. Alternatively, the wavelength allocated by the optical transmission control unit 56 may be used only between the optical transmission device 10e and the central station 20e, and a signal may be transmitted by time division multiplexing using one wavelength between the distributed stations 30e and the optical transmission device 10e, similarly to the signal transmission system 6 illustrated in FIG. 1 described above.

Note that the central station 20e may be, for example, a Wi-Fi (registered trademark) controller, and each of the distributed stations 30e may be, for example, a Wi-Fi (registered trademark) access point. The signal transmission system 1b is not necessarily a mobile communication system, and may be a wireless communication system other than the mobile communication system.

As described above, in the signal transmission system 1e according to the sixth embodiment of the present invention, the central station 20e performs scheduling of time and frequency in the wireless section. Then, the communication control unit 21e of the central station 20e transmits scheduling result information indicating a scheduling result (that is, result of resource allocation of time and frequency for each of traffic flows in the wireless section) and traffic flow information indicating the state of the traffic flows in the wireless section (for example, number of wireless terminals, identifiers for respective traffics, or the like) to the information transmission unit 51 of the wireless controller 50. The information transmission unit 51 of the wireless controller 50 transmits the traffic flow information and the scheduling result information acquired from the central station 20e to the optical transmission control unit 56 of the optical transmission device controller 55. Then, the optical transmission control unit 56 of the optical transmission device controller 55 allocates a plurality of wavelengths to the respective traffic flows for the wired section on the basis of the acquired traffic flow information and scheduling result information.

With such a configuration, the signal transmission system 1e according to the sixth embodiment can transmit a plurality of traffic flows in parallel by wavelength division multiplexing even in the wired section between the central station 20e and the distributed stations 30e. As a result, the signal transmission system 1e can reduce occurrence of a delay caused by signal serialization by time division multiplexing, which occurs in the wired section of the conventional signal transmission system 6.

Furthermore, in a conventional mobile communication system such as the signal transmission system 6 described above, in a case where a plurality of wavelengths is allocated in one base station, a wavelength corresponding to a traffic flow to which a frequency resource is not allocated in a wireless section of a certain time section is wasted. As a result, excessive wavelength allocation occurs, and the utilization efficiency of wavelengths decreases.

On the other hand, in the signal transmission system 1e according to the sixth embodiment described above, the optical transmission device controller 55 allocates only a wavelength corresponding to a traffic flow to which a frequency resource is allocated in the wireless section for each time section. As a result, the number of wavelengths used is reduced, and the utilization efficiency of wavelengths is improved.

According to the above-described embodiments, a signal transmission system includes one or more first communication devices that accommodate one or more wireless terminals that transmit a plurality of traffic flows, and an optical transmission device that transmits a signal transmitted between the first communication devices and a second communication device. For example, the signal transmission system is the signal transmission system 1, 1a to 1b in the embodiments, the wireless terminals are the wireless terminals 40 in the embodiments, the first communication devices are the base stations 30 or the distributed stations 30a, 30b in the embodiments, the second communication device is the server 20 or the central station 20a, 20b in the embodiments, and the optical transmission device is the optical transmission device 10, 10b in the embodiments.

The first communication device includes a communication control unit (a communication controller). For example, the communication control unit is the communication control unit 31, 21 in the embodiments. The communication control unit performs scheduling of time and frequency for each of the traffic flows and transmits scheduling result information indicating a result of the scheduling and traffic flow information indicating a state of the traffic flows in a wireless section to the optical transmission device. The optical transmission device includes an optical transmission control unit (an optical transmission controller). For example, the optical transmission control unit is the optical transmission control unit 11, 11b in the embodiments. The optical transmission control unit allocates a wavelength in a wired section to each of the traffic flows for each time section on the basis of the scheduling result information and the traffic flow information transmitted from the communication control unit (the communication controller).

Furthermore, according to the above-described embodiments, a signal transmission system includes one or more first communication devices that accommodate one or more wireless terminals that transmit a plurality of traffic flows, an optical transmission device that transmits a signal transmitted between the first communication devices and a second communication device, and a controller that controls the optical transmission device. For example, the signal transmission system is the signal transmission system 1c to 1e in the embodiments, the wireless terminals are the wireless terminals 40 in the embodiments, the first communication devices are the base stations 30c or the distributed stations 30d, 30e in the embodiments, the second communication device is the server 20 or the central station 20d, 20e in the embodiments, the optical transmission device is the optical transmission device 10c to 10e in the embodiments, and the controller is the optical transmission device controller 55 in the embodiments.

The first communication device includes a communication control unit (a communication controller). For example, the communication control unit is the communication control unit 31c, 31d, 21e in the embodiments. The communication control unit performs scheduling of time and frequency for each of the traffic flows and transmits scheduling result information indicating a result of the scheduling and traffic flow information indicating a state of the traffic flows in a wireless section to the optical transmission device. The controller includes an optical transmission control unit (an optical transmission controller). For example, the optical transmission control unit is the optical transmission control unit 56 in the embodiments. The controller allocates a wavelength in a wired section to each of the traffic flows for each time section on the basis of the scheduling result information and the traffic flow information transmitted from the communication control unit (the communication controller). The second communication device includes a control execution unit (a control executor). For example, the control execution unit is the control execution unit 11c to 11e in the embodiments.

Note that, in the signal transmission system described above, the optical transmission device may transmit a signal obtained by wavelength division multiplexing a plurality of traffic flows to the second communication device.

Note that, in the signal transmission system described above, the optical transmission control unit (the optical transmission controller) may allocate the wavelength only to the traffic flow to which the frequency is allocated in the wireless section by the scheduling.

Note that, in the signal transmission system described above, the communication control unit may perform scheduling on the basis of information indicating the remaining amount of a buffer for each of the traffic flows in the wireless terminals or information indicating the quality of a wireless channel.

Note that the traffic flow information may include an identifier for identifying the wireless terminal, an identifier for identifying the traffic flow, an identifier for identifying a class of quality of service, an identifier for identifying a network slice, a slot ID, a symbol ID, a resource block ID, or a layer number of MIMO.

Furthermore, according to the above-described embodiments, an optical transmission device may transmit a signal transmitted between one or more first communication devices that accommodate one or more wireless terminals that transmit a plurality of traffic flows and a second communication device. For example, the optical transmission device is the optical transmission device 10, 10b to 10e in the embodiments, the wireless terminals are the wireless terminals 40 in the embodiments, the first communication devices are the base stations 30, 30c or the distributed stations 30a, 30b, 30d, 30e in the embodiments, and the second communication device is the server 20 or the central station 20a, 20b, 20d, 20e in the embodiments.

The optical transmission device includes an optical transmission control unit. For example, the optical transmission control unit is the optical transmission control unit 11, 11b, 56 in the embodiments. The optical transmission control unit (an optical transmission controller) allocates a wavelength in a wired section to each of the traffic flows for each time section on the basis of the scheduling result information indicating a result of scheduling of time and frequency for each of the traffic flows and traffic flow information indicating a state of the traffic flows in a wireless section.

A part of the configuration of the signal transmission system 1, 1a to 1 e in the above-described embodiments may be implemented by a computer. In that case, a program for implementing this function may be recorded in a computer-readable recording medium, and the program recorded in the recording medium may be read and executed by a computer system to implement this function. Note that, the “computer system” referred to herein includes an OS and hardware such as peripheral equipment. In addition, the “computer-readable recording medium” refers to a portable medium such as a flexible disk, a magneto-optical disk, a ROM, or a CD-ROM, or a storage device such as a hard disk built in a computer system. Further, the “computer-readable recording medium” may include a medium that dynamically holds the program for a short period of time, such as a communication line in a case where the program is transmitted via a network such as the Internet or a communication line such as a telephone line, and a medium that holds the program for a certain period of time, such as a volatile memory inside a computer system serving as a server or a client in that case. In addition, the program described above may be for implementing a part of the function described above, may be implemented in a combination with a program already recorded in a computer system, or may be implemented with a programmable logic device such as a field programmable gate array (FPGA).

Although the embodiments of the present invention have been described in detail with reference to the drawings, specific configurations are not limited to the embodiments and include design and the like within the gist of the present invention.

### REFERENCE SIGNS LIST

1, 1a to 1e, 6 Signal transmission system
10, 10a to 10e Optical transmission device
11 Optical transmission control unit
11c to 11e Control execution unit
20 Server
20a, 20b, 20d, 20e Central station
21, 21e Communication control unit
30, 30c Base station
30a, 30b, 30d, 30e Distributed station
31, 31c, 31d Communication control unit
40 Wireless terminal
50 Wireless controller
51 Information transmission unit
55 Optical transmission device controller
56 Optical transmission control unit
60, 60a Optical transmission device
70 Server
70a Central station
80 Base station
80a Distributed station
90 Wireless terminal

1. A signal transmission system comprising: one or more first communication devices that accommodate one or more wireless terminals that transmit a plurality of traffic flows; and an optical transmission device that transmits a signal transmitted between the first communication devices and a second communication device,
wherein each of the first communication devices includes
a communication control unit that performs scheduling of time and frequency for each of the traffic flows and transmits scheduling result information indicating a result of the scheduling and traffic flow information indicating a state of the traffic flows in a wireless section to the optical transmission device, and
the optical transmission device includes
an optical transmission control unit that allocates a wavelength in a wired section to each of the traffic flows for each time section on a basis of the scheduling result information and the traffic flow information transmitted from the communication control unit.

2. A signal transmission system comprising: one or more first communication devices that accommodate one or more wireless terminals that transmit a plurality of traffic flows; an optical transmission device that transmits a signal transmitted between the first communication devices and a second communication device; and a controller that controls the optical transmission device,
wherein each of the first communication devices includes
a communication control unit that performs scheduling of time and frequency for each of the traffic flows and transmits scheduling result information indicating a result of the scheduling and traffic flow information indicating a state of the traffic flows in a wireless section to the optical transmission device,
the controller includes
an optical transmission control unit that allocates a wavelength in a wired section to each of the traffic flows for each time section on a basis of the scheduling result information and the traffic flow information transmitted from the communication control unit, and
the second communication device includes
a control execution unit that controls communication in the wired section according to allocation of the wavelength by the optical transmission control unit.

3. The signal transmission system according to claim 1 or 2,
wherein the optical transmission control unit allocates the wavelength only to the traffic flow to which the frequency is allocated in the wireless section by the scheduling.

4. The signal transmission system according to claim 1 or 2,
wherein the traffic flow information includes an identifier for identifying the wireless terminal, an identifier for identifying the traffic flow, an identifier for identifying a class of quality of service, an identifier for identifying a network slice, a slot ID, a symbol ID, a resource block ID, or a layer number of MIMO.

5. An optical transmission device that transmits a signal transmitted between one or more first communication devices that accommodate one or more wireless terminals that transmit a plurality of traffic flows and a second communication device, the optical transmission device comprising
an optical transmission control unit that allocates a wavelength in a wired section to each of the traffic flows for each time section on a basis of scheduling result information indicating a result of scheduling of time and frequency for each of the traffic flows and traffic flow information indicating a state of the traffic flows in a wireless section.

6. A signal transmission method by a signal transmission system including: one or more first communication devices that accommodate one or more wireless terminals that transmit a plurality of traffic flows; and an optical transmission device that transmits a signal transmitted between the first communication devices and a second communication device, the signal transmission method comprising:
a communication control step of, by each of the first communication devices, performing scheduling of time and frequency for each of the traffic flows and transmitting scheduling result information indicating a result of the scheduling and traffic flow information indicating a state of the traffic flows in a wireless section to the optical transmission device; and
an optical transmission control step of, by the optical transmission device, allocating a wavelength in a wired section to each of the traffic flows for each time section on a basis of the scheduling result information and the traffic flow information transmitted by the communication control step.

7. A signal transmission method by a signal transmission system including: one or more first communication devices that accommodate one or more wireless terminals that transmit a plurality of traffic flows; an optical transmission device that transmits a signal transmitted between the first communication devices and a second communication device; and a controller that controls the optical transmission device, the signal transmission method comprising:
a communication control step of, by each of the first communication devices, performing scheduling of time and frequency for each of the traffic flows and transmitting scheduling result information indicating a result of the scheduling and traffic flow information indicating a state of the traffic flows in a wireless section to the optical transmission device;
an optical transmission control step of, by the controller, allocating a wavelength in a wired section to each of the traffic flows for each time section on a basis of the scheduling result information and the traffic flow information transmitted by the communication control step; and
a control execution step of, by the second communication device, controlling communication in the wired section according to allocation of the wavelength in the optical transmission control step.

8. A signal transmission method by an optical transmission device that transmits a signal transmitted between one or more first communication devices that accommodate one or more wireless terminals that transmit a plurality of traffic flows and a second communication device, the signal transmission method comprising:
an acquisition step of acquiring scheduling result information indicating a result of scheduling of time and frequency for each of the traffic flows and traffic flow information indicating a state of the traffic flows in a wireless section; and
an optical transmission control step of allocating a wavelength in a wired section to each of the traffic flows for each time section on a basis of the scheduling result information and the traffic flow information acquired by the acquisition step.
